(19) United States
(12) Patent Application Publication
(10) Pub. No.: US 2017/0316218 A1
(43) Pub. Date: Nov. 2, 2017

(54) METHOD OF PREVENTING PRY FOR RANDOM ACCESS MEMORY

(71) Applicant: National Taipei University of Technology, Taipei City (TW)

(72) Inventors: Shaw Hwa HWANG, Taipei City (TW); Bing Chih YAO, Taipei City (TW); Kuan Lin CHEN, Taipei City (TW); Yao Hsing CHUNG, Taipei City (TW); Chi Jung HUANG, Taipei City (TW); Cheng Yu YEH, Taipei City (TW); Shun Chieh CHANG, Taipei City (TW); Li Te SHEN, Taipei City (TW); Chao Ping CHU, Taipei City (TW); Ning Yun KU, Taipei City (TW); Tzu Hung LIN, Taipei City (TW); Ming Che YEH, Taipei City (TW)

(21) Appl. No.: 15/143,672

(22) Filed: May 2, 2016

(51) Int. Cl. G06F 21/62; G06F 21/79; H04L 9/06; H04L 9/30

(52) U.S. Cl. CPC G06F 21/62; H04L 9/302; G06F 21/79; H04L 9/0625

(57) ABSTRACT

The present invention provides a method of preventing pry for random access memory. A functional interface is designed between a computer program and a random access memory. When the computer program wants to store an original data into the random access memory, an encryption procedure is processed on the original data first, and then stoic into the random access memory for being an encrypted data. When the computer program ants to fetch related data float the random access memory, the functional interface is used to fetch the encrypted data for decryption, so that the original data is obtained for calculation.

### FIELD OF THE INVENTION

The present invention relates to a method of preventing pry for random access memory, a d more particularly to a method of encryption procedure employed in random access memory.

### BACKGROUND OF THE INVENTION

Referring to FIG. 1, when a mathematical operation is processed in a program 1 in a computing equipment (such as PC, smart phone), some important and common data 3 are often stored directly into RAM (random access mentor) 2. When the data 3 are required for calculating, the data 3 are fetched from RAM 2 for calculation.

Taking a game program as an example, the life value of a player will be stored in RAM 2. When the life value of the player is recovered or harmed, the program 1 will read the data 3 of the life value for performing addition or subtraction. After calculation, it will stored into RAM 2 again for next calculation.

Referring to FIG. 2, for some information security in Internet environment to prevent from leaking personal data (such as the number of a credit card), before RAM 21 and RAM 22 of two computing equipments send data through Internet, the data will be performed with encryption (41, 42) first, and then to be sent to the other side through Internet for decryption 52, 51. Even though the data are protected during Internet transmission, the data after decryption in RAM 22, 21 are opened to the public.

Referring to FIG. 3, someone having the intent to pry can embed a Trojan horse virus into the computing equipment for scanning RAM 2 to pry about specific data 3 by “fuzzy search”, and then to alter the data 3 in RAM 2.

In existing Windows software, there is a “Cheat Engine” software (CE), which is an open source coding having the capability for “memory scanning”. By using the “Cheat Engine”, a user can search and alter the data in memory of the computer. For example, by altering the the data in memory, the user can obtain some benefits such as unlimited life value, time or ammunition. Some information security environments other than games can also utilize similar techniques to ply about personal privacy.

### SUMMARY OF THE INVENTION

The object of the present invention is to provide a method of preventing pry for random access memory. A functional interface is designed between a computer pro gram and a random access memory; when the computer program wants to store an original data into the random access memory, an encryption procedure is processed on the original data first, and then store into the random access memory for being an encrypted data; when the computer program wants to fetch related data from the random access memory, the functional interface is used to fetch the encrypted data for decryption procedure, so that the original data is obtained for calculation.

The encryption procedure uses a specific encryption key for XOR operation on the original data to firm the encrypted data; the decryption procedure uses the specific encryption key for XOR operation on the encrypted data to form the original data.

The encryption procedure and the decryption procedure can be performed in accordance with Data Encryption Standard (DES).

The encryption procedure and the decryption procedure can be performed in accordance with Advanced Encryption Standard (AES).

The encryption procedure and the decryption procedure can be performed in accordance with RSA Encryption Algorithm.

### BRIEF DESCRIPTION OF THE DRAWINGS

FIG. 1 shows schematically the data access between computer program and a random access memory.

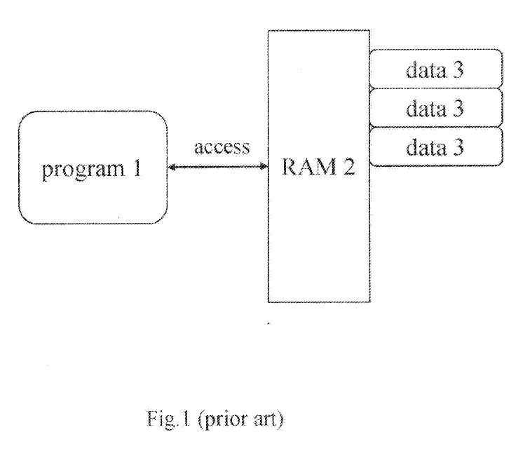

FIG. 2 shows schematically the encryption and the decryption for accessing data between two random access memories of two computer equipments for information security in Internet environment.

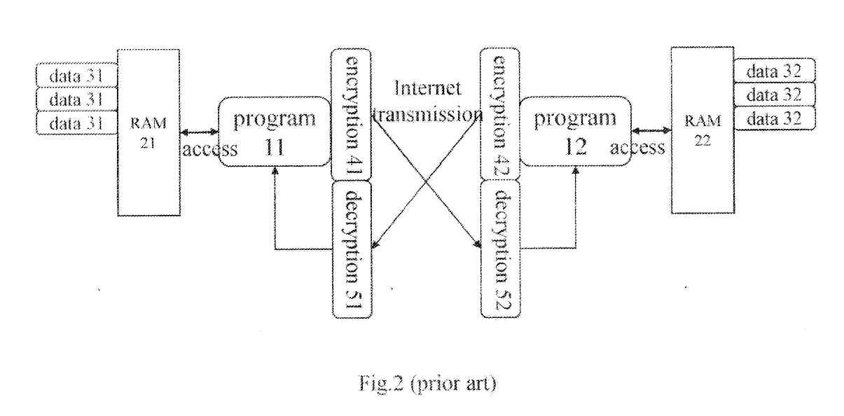

FIG. 3 shows schematically that a pryer embeds a Trojan horse virus into the computing equipment for scanning and “fuzzy search” the random access memory to pry about specific data.

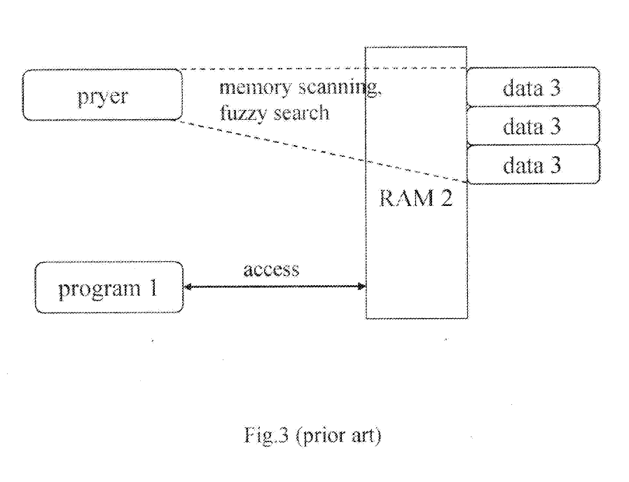

FIG. 4 shows schematically a method of preventing pry for random access memory according to the present invention.

FIG. 5 shows schematically an embodiment of the method of preventing pry for random access memory according to the present invention.

### DETAILED DESCRIPTIONS OF THE PREFERRED EMBODIMENTS

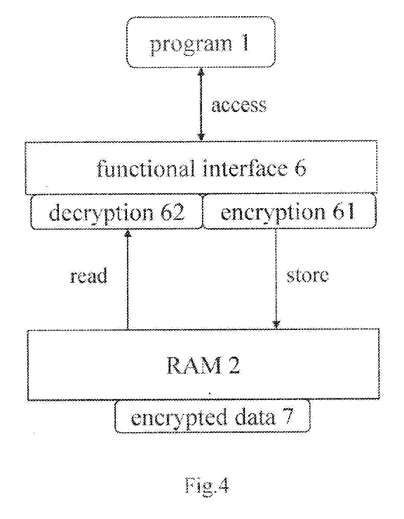

Referring to FIG. 4, which shows schematically a method f preventing pry for random access memory according to the present invention. In order to prevent random access memory from being pried, before the computer program I stores important data into RAM 2 temporarily, the data are processed through a functional interface 6 for performing encryption 61 first, and then to be stored into RAM 2. Therefore data in RAM 2 are encrypted data 7, and cannot be easily scanned and pried. When the program 1 requires for calculation, just utilize the functional interface 6 to read the encrypted data 7 in RAM 2, and then perform decryption 62 to obtain the original data for calculation. In this way, the data in RAM 2 therefore cannot be easily scanned and pried.

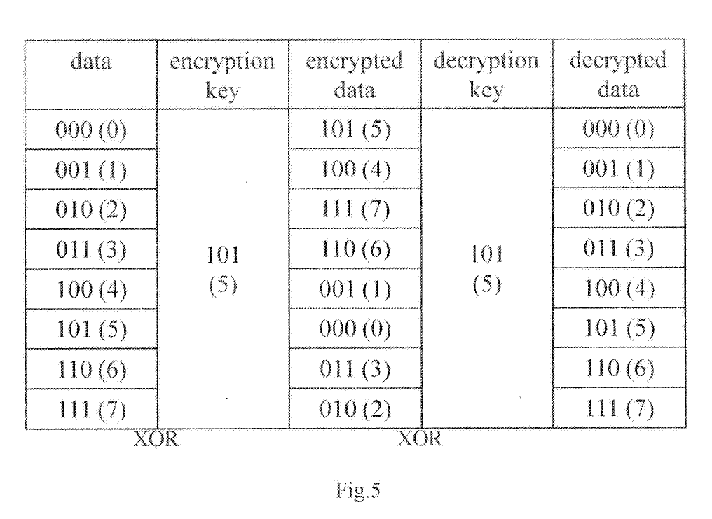

Referring to FIG. 5, which shows schematically an embodiment of the method of preventing pry for random access memory according to the present invention. The data in computer equipment are represented by 0 and 1, for example, digits 0˜7 are represented by 3 bits as below:

000 represents 0

001 represents 1

010 represents 2

011 represents 3

100 represents 4

101 represents 5

110 represents 6

111 represents 7

In logic gate operation, there is an XOR operation, the rule thereof is: when two equal value of bits are operated by XOR, the result is 0; when two unequal value of bits are operated by XOR, the result is 1, as shown below:

0 XOR 0=0

1 XOR 0=1

0 XOR 1=1

1 XOR 1=0

XOR operation has reversibility. For example, if the data of computer equipment is 111, an encryption key 101 is XOR operated on 111, then:

If 010 is again XOR operated by the encryption key 101, the original data 111 is obtained, as shown below:

010 XOR 101=111

FIG. 5 shows schematically an embodiment of the method of preventing pry for random access memory according to the present invention. The three bits of 0˜7 digits are XOR operated by the encryption key 101, the three bits of 5, 4, 7, 6, 1, 0, 3, 2 digits are obtained. During decryption, the encryption key 101 is still used for XOR operation, and the three bits of the original 0˜7 digits are obtained.

Having XOR operated by the encryption key, data will show irregularity, nonlinearity. Someone intends to pry the encrypted data by “fuzzy search” or “memory scanning”, the original data cannot be obtained. The data in random access memory XOR operated by the encryption key according to the present invention are ensured to be absolutely safe.

XOR operation by the encryption key is not the only method, other methods such as Data Encryption Standard (DES), Advanced Encryption Standard (AES) and RSA Encryption Algorithm are described as below.

Data Encryption Standard (DES) is the same as XOR encryption to be a symmetric-key block algorithm. Symmetric-key means that the encryption key is the same as the decryption key. DES uses 56 bits key, and is still a quite convenient encryption standard. DES employs a series of complicated operation on a data with fixed length to become an encrypted data with the same length. The block length of DES is 64 bits.

Advanced Encryption Standard (AES) is also called Rijndael Encryption algorithm. AES is used to complement DES, and is also a symmetric-key algorithm. AES has a fixed block length of 128 bits, but the key length can be 128, 192 or 256 bits. The AES encryption procedures are operated on a 4×4 bit matrix.

RSA Encryption Algorithm is a unsymmetric-key algorithm, and is much slower and more complicated than DES and other symmetric-key algorithms, but is ensured to be absolutely safe.

The speeds of the above-mentioned encryption algorithms for random access memory are XOR>DES>AES>RSA. If some data require calculation frequently, speed is the major concern to select ale encryption algorithm, such as the life value, time or ammunition of a game player.

If safety is the major concern, then RSA>AES>DES>XOR. When the data arc not changed frequently or just fetched statically, such as the number of credit card, the more complicated encryption algorithm had better to be employed.

The scope of the present invention depends upon the following claims, and is not limited by the above embodiments.

What is claimed is:

1. A method of preventing pry for random access memory, a functional interface is designed between a computer program and a random access memory, when the computer program wants to store an original data into the random access memory, an encryption procedure is processed on the original data first, and then store into the random access memory for being an encrypted data; when the computer program wants to fetch related data from the random access memory, the functional interface is used to fetch the encrypted data for decryption procedure, so that the original data is obtained for calculation

2. The method of preventing pry for random access memory according to claim 1, herein the encryption procedure uses a specific encryption key for XOR operation on the original data to form the encrypted data; the decryption procedure uses the specific encryption key for XOR operation on the encrypted data to form the original data.

3. The method Pf preventing pry for random access memory according to claim 1, wherein the encryption procedure and the decryption procedure are performed in accordance with Data Encryption Standard (DES).

4. The method of preventing pry for random access memory according to claim 1, wherein the encryption procedure and the decryption procedure are performed in accordance with Advanced Encryption Standard (AES).

5. The method of preventing pry for random access memory according to claim 1, wherein the encryption procedure and the decryption procedure are performed in accordance with RSA Encryption Algorithm.
